(19) United States
(12) Patent Application Publication
(10) Pub. No.: US 2015/0097816 A1
(43) Pub. Date: Apr. 9, 2015

(54) WIRELESS HANDHELD CONTROLLER

(71) Applicant: Jurij Beklemisev, Vilnius (LT)

(72) Inventor: Jurij Beklemisev, Vilnius (LT)

(21) Appl. No.: 14/507,858

(22) Filed: Oct. 7, 2014

Related U.S. Application Data
(60) Provisional application No. 61/887,454, filed on Oct. 7, 2013.

(51) Int. Cl. G06F 3/0362

(52) U.S. Cl. CPC G06F 3/0362
USPC 345/184

(57) ABSTRACT

A wireless handheld controller includes a housing and a plurality of scroll wheel assemblies mounted in the housing. Each of the scroll wheel assemblies including a rotatable member and a key adjacently associated with respective rotatable members. The wireless handheld controller also includes circuitry in electrical communication with the scroll wheel assemblies. The circuitry is configured to control the device and provide remote control of equipment in communication with the device. The circuitry comprising a movement sensing system configured to sense movement of the rotatable member, and a key sensing system configured to sense a mode signal received from the key. The circuitry configured to operate in a first mode initiated with the mode signal in which each one of the plurality of scroll wheel assemblies are representative of one of a plurality of input channels, and a second mode initiated with the mode signal in which each one of the plurality of scroll wheel assemblies are representative of parameters of only one of the plurality of input channels.

### RELATED APPLICATIONS

The present patent document claims the benefit of the filing date under 35 U.S.C. §119 of U.S. Provisional Patent Application Ser. No. 61/887,454, filed Oct. 7, 2013, which is hereby incorporated by reference.

### BACKGROUND

1. Technical Field

The present invention relates in general to remote control of equipment and more particularly to control surfaces for sound, lighting, video and such equipment.

### 1. BACKGROUND INFORMATION

Devices can be controlled remotely using a control board, or a computer, or a control board that includes a computer. Control boards typically include indicators of conditions of the devices and variable switches and/or knobs to control the remote device(s). A computer may generate a graphical user interface that can be used to control the remote device(s).

### BRIEF SUMMARY

Engineers can use consumer type touch tablet computer devices to adjust an audio sound mix or program intelligent lighting in indoor as well as outdoor venues. However such devices often fail when used in harsh environments of extreme temperature, mechanical shock, dirt and moisture. In addition, many of these touch screen based user interfaces lack input speed regarding receipt of user input commands via the touch screen.

Embodiments of a hand-held portable wireless control surface device, as described herein, do not exhibit such issues. Consumer type tablet computers are now common tools that engineers use on live events to mix sound, program intelligent lighting while walking the venue and/or stage. These consumer type tablet computers typically run special remote control apps that control remote equipment over a wireless connection. However consumer type equipment chosen to perform professional highly specialized tasks include a number of drawbacks such as: lack of rigid mechanical design to withstand kicks and drops; failure of touch screens to operate reliably when in contact with moisture of any kind, such as sweat, skin oil, rain drops, etc.; regular erroneous input of information; slower input of information compared to computer keyboards or other user input device; lack of a field swappable battery; and lack of a replacement aerial option for stronger wireless communication link.

Contrary to notion that a sound engineer can hold a touch tablet computer running a remote control app with only one hand, while operating the user interface with the other hand, in reality an engineer typically holds the touch tablet with both hands and operates the user interface of a remote control app with fingers of both hands. The chances are relatively high of the touch tablet getting accidentally damaged by kicking or dropping from considerable heights in harsh environments, such as sites where live concerts are set up, due to concrete floors; high stage structures; and lots of metallic objects with harsh corners. In addition to static structures, there is high traffic due to workers rolling flight-cases and moving other equipment in the area. Accordingly, the chances of a sound engineer accidentally tripping over or rolling over some other equipment while using a touch tablet computer is quite high. When damage to a consumer touch table occurs due to these conditions, the chances of consumer grade equipment recovering from such damage are next to none. Such environments are simply not what is known as “home or office use.” Only professional grade equipment can survive in such an environment.

Human fingers in their natural condition have some amount of oil on their surface. Also human fingers sweat just like other parts of the human body. In stressful situations the human body tends to sweat more. Touch screens are typically designed to use various techniques to mitigate the effect of oil or sweat smearing into the screen. Yet such techniques typically operate using some “normal” hardness and smoothness of human fingers of a person at home or office. Therefore other conditions of hardness, smoothness, oil or sweat of fingers, resulting from operation in an environment different from the home and office, are not “normal,” and therefore many of the techniques fail. For example, any water that comes in contact with touch screen typically causes multiple input errors, and when flooded with water, touch screens can fail to receive any user input and may generate input on their own.

Even under nearly perfect environmental conditions touch screens can input data erroneously —by inputting data not intended by the user to be input. Under some conditions, such as when a user is preparing a text message, such erroneous input of data can be simply corrected by repeating the input. However in critical applications, such as operating equipment for a live event, such erroneous input can get very costly, and can even ruin a show.

Touch screens are also typically slow regarding information input due to their design—whereas operation of other equipment, such as audio equipment is intense. Data input speed, such as text input capability can be significantly lower in touch screen devices when compare with traditional computer keyboard. For example, a study showed that users could type at 25 words per minute (wpm) for a touchscreen keyboard compared with 58 wpm for a standard keyboard.

In addition, the advantage of smaller size and weight provided by consumer type touch tablet computers is offset by the fragility of the device. Also, the human-machine interaction of consumer type touch tablet computers lacks any form of tactile feel of hardware faders, knobs and buttons of purpose built control boards. Such tactile feeling can provide a user with greater control therefore chances of errors caused by bad human-machine interaction can be minimized. Tactile feeling explains why text input using a keyboard is faster than using a touchscreen. Data input speed, such as text input capability, can be significantly lower in touch screen devices when compare with traditional computer keyboard data input.

Equipment operation during a live event, such as sound equipment operation can get very intense—especially during festivals and other larger events. Thus, there is no room for errors and error-correction during a live performance. To avoid undesirably slow operation of equipment such as sound equipment, some engineers follow a common practice of purposefully limiting the complexity, such as by mixing live performances and shows with fewer numbers of audio channels when using touch screen devices. In applications with complex requirements, such as live performances in which a large number of audio channels are mixed at a high pace, touch screen device based remote control approaches can fail. Sound engineers can then resort to traditional sound mixing consoles that include a control surface with lots of hard keys, faders, knobs and other types of controls, while also losing the advantages of wireless control. In some applications, only such hard surface controls allow reliable equipment control at high speed.

A purpose-built control board can be a preferred choice to operate sound, lighting, video and other equipment because such a board can provide access to a large number of parameters to control, and a good human-machine interaction can be achieved by making use of purpose-specific built user interfaces. However, the size and weight of such a control board causes problems for a user when setting up live events since the control boards need a shelter to be protected from the effects of moisture such as rain and snow, which is typically in the form of a booth in the middle of a venue. Such a booth obstructs the view of stage for an audience, which becomes a major issue especially in outdoor live events. In addition, such control boards are typically set away from the stage a considerable distance and use long cabling to connect to the equipment the board monitors and controls, which is another major issue that sometimes makes some live event productions difficult or impossible.

Professional battery powered equipment for live events can include a replaceable battery whether of non-rechargeable or rechargeable type. Due to the nature of a live event, it is absolutely required for equipment to remain operational at all times. Battery replacement time is typically the only “down time” allowed. There is no battery powered equipment for live events—such as wireless microphone—with built-in non-replaceable batteries. Touch tablet computers, however, typically feature a built-in non-replaceable battery, which can render remotely controlled device non-operational during a time when the touch tablet computer is recharging. Touch tablet computers designed for home and office use typically allow frequent recharging. Issues with battery life and frequency of recharge become very apparent in devices with high energy demand, such as devices performing wireless communication.

Home and office use typically allows close proximity to wireless access points so that bandwidth remains high for Internet networking. For applications such as live sound applications, ranges of wireless communication can be hundreds of meters, and remote control of audio equipment may not be high-bandwidth like in Internet-networking applications. In fact, remote control in audio system control applications can be performed over a communication link such as a low-speed low-bandwidth serial data communication, using hardware such as low-speed COM ports. In some cases, the wireless range can be increased at a cost of low-bandwidth, low speed data transfer. Touch tablet computers typically have a built-in aerial for wireless communication, but typically allow no replacement or swapping of the wireless interface itself for a more appropriate one. The bottom line is remote control of equipment at the professional level typically requires a grade of dedicated equipment that is other than consumer touch tablet computers.

The nature of live events typically requires the show to go on despite weather conditions unless they cause danger to the performers or the audience. The aesthetics and set-up of live events is therefore frequently sacrificed by shelters housing mixing and lighting consoles and other equipment. Often, such shelters are positioned in the middle of a venue (front-of-house), which can cause a major obstruction of stage view for the audience. The capability of wireless remote control can be a great entertainment technology improvement at least by getting rid of objects obstructing the audience view. However the drawbacks of using touch tablet computers as remote control devices diminish the benefits of such an improvement. Embodiments of the hand-held wireless control surface described herein aid in maintaining and developing the improvement.

The issues addressed above are solved by a hand-held portable wireless remote device as described herein. The choice and layout of components for the user interface can be influenced by the goal of creating a compact hand-held battery powered wireless remote control device suitable for mixing sound, programming and operating lights and so on. The wireless remote control device can be of rigid construction so as to allow it to be subjected to mechanical shock without damage or other detrimental effect. The control surface of the wireless remote control device can be operated with wet and/or dirty hands. The design of the wireless remote control device can maximize wireless communication range and include sufficient battery life. For example, the battery of embodiments of the wireless remote control device is replaceable.

Thus, some of the challenges of building a control board are:

1) accessing a large number of parameters of the process being controlled, such as the process of—sound mixing, operating lighting, video or another task or process;
2) achieving a reasonable size and weight, because it affects logistics and production of live events themselves; and
3) achieving good human-to-machine interaction—that is, to make operating equipment efficient error-free, reliable, quick, and stress-free.

Many of the issues mentioned above are solved by a hand-held portable wireless battery powered remote control device as described herein. The user interface of the device is designed to achieve the goal of allowing quick access to large number for controllable parameters. The choice of elements of the device is influenced by better tactile feeling and the device may be operated with wet and/or dirty hands. The device can be of rigid construction to be subjected to mechanical shock without damage or other detrimental effect. The device can maximize wireless communication range by using dedicated high-range wireless communication standards and chips as well as providing an option of replaceable aerials. The device can include a replaceable battery to reduce the down-time.

### BRIEF DESCRIPTION OF THE DRAWINGS

FIG. 1 is a perspective view of an example embodiment of a wireless handheld controller.

FIG. 2 illustrates an example embodiment of a scroll wheel assembly.

FIG. 3 illustrates another example embodiment of a part of a scroll wheel assembly.

FIG. 4 is a perspective view of another example embodiment of a portion of a wireless handheld controller absent a housing.

FIG. 5 illustrates an example of embodiment of a portion of a wireless handheld controller that includes a mounting member and a base member.

FIG. 6 illustrates another example embodiment of a portion of a wireless handheld controller.

FIG. 7 illustrates examples of a user interface in embodiments of a wireless handheld controller.

FIG. 8 illustrates an example of a portion of a user interface of an embodiment of a wireless handheld controller.

FIG. 9 illustrates a portion of another example user interface of an embodiment of a wireless handheld controller.

### DETAILED DESCRIPTION OF THE DRAWINGS AND THE PRESENTLY PREFERRED EMBODIMENTS

Embodiments of a wireless handheld controller can be used for, but are not limited to mixing sound. Although use of the wireless handheld controller is described in some instances in the context of audio sound mixing and control, other applications, such as lighting control are also contemplated. Accordingly, the wireless handheld controller is not limited to use in only audio sound mixing/control applications.

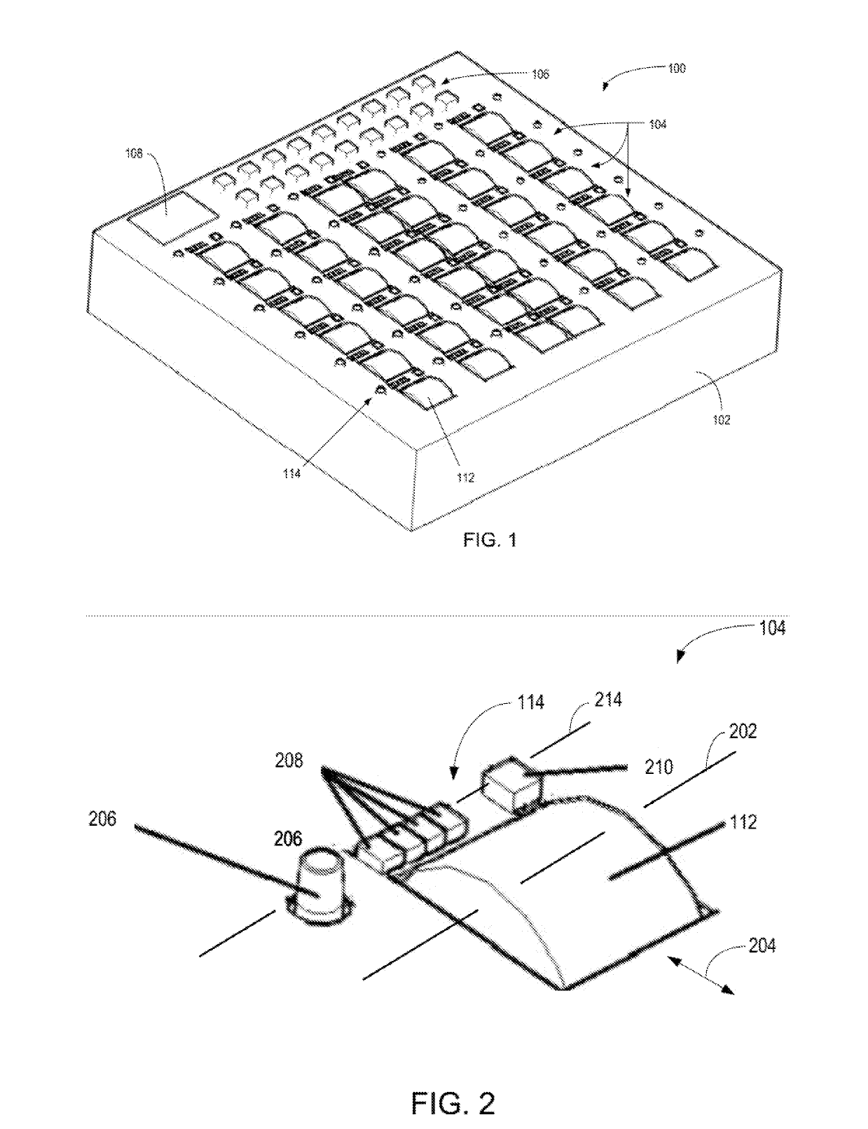

FIG. 1 is a perspective view of an example embodiment of a wireless handheld controller 100. The wireless handheld controller 100 can include a housing 102 and a user interface. The user interface can include scroll wheel assemblies 104, function keys 106, and a display 108. In the illustrated embodiment, there are thirty-six scroll wheel assemblies 104 disposed in openings in the housing 102 in a group to form a 6×6 matrix, which may be referred to as a parameter section of the user interface. In addition, there are eighteen function keys 106 disposed in openings in the housing 102 in a group to form a 2×9 matrix, which may be referred to as a control section of the user interface. The matrix of the scroll wheel assemblies 104 and the matrix of the function keys 106 may be mounted in a same surface of the housing 102. The display 108 can also be disposed in the same surface, in an opening in the housing 102. In other example embodiments, additional or fewer scroll wheel assemblies 104 and/or function keys 106 may be included in matrices groups in the housing 102. In addition, or alternatively, in other example embodiments, the layout and/or relative locations of the specific elements included in or on the housing 102 may be different.

Each of the scroll wheel assemblies 104 can include a rotatable member 112 and a scroll wheel interface section 114. In an example embodiment, the function keys 106 are push buttons that include a contact which closes while the push button is being actuated to a depressed state. In other examples, other forms of rotatable devices, such as a rotatable knob, may be used for the rotatable members 112, and other forms of actuators may be used for the function keys 106. In addition, in other embodiments other elements, such as indicators or sliders may be included as part of the user interface.

During operation, the scroll wheel assemblies 104 are available to a user to adjust one or more channels of one or more remote devices being controlled by the wireless handheld controller 100. In an example application, the wireless handheld controller 100 may be used to control a mixing engine that controls audio channels. In a first mode (main mode) of the wireless hand held controller 100, each of the scroll wheel interfaces 104 may be associated with a different channel, such as an audio channel, whereas in a second mode (channel edit mode) each of the scroll wheel interfaces 104 may be associated with parameters of a single channel, such as an audio channel. The function keys 106 may be pre-defined, or defined by a user. Each of the function keys are associated with different functions of a channel. Thus, selecting any one of the function keys 106 assigns the corresponding function associated with the selected function key 106 to the scroll wheel assemblies 104 to control a different parameter of the channels. Since at least some of the function keys 106 are user definable, any function can be assigned to any function key.

FIG. 2 illustrates an example of a scroll wheel assembly 104. As shown in FIG. 2, the rotatable member 112 of the scroll wheel assembly 504 is rotatable about an axis 202 that extends substantially parallel with a substantially planar surface of the housing 502. The rotatable member 112 is laterally movable by a user within the opening relative to the housing 102 in two directions that are generally perpendicular to the rotational axis 202, as illustrated with arrow 204.

The scroll wheel assembly 104 may represent a block that the user interface of the control surface of the device is arranged in. For example, each scroll wheel assembly 104 may represent a channel block that can be used to independently control one of a group of separate channels. Alternatively, each scroll wheel assembly 104 may represent a parameter block, which may represent and be used to independently control one of the parameters associated with a single channel, such that each of the parameter blocks represent different parameters of only one channel.

The scroll wheel interface section 114 can include a key 206, an indicator set 208, and a grouping indicator 210 for each of the scroll wheel assemblies 112. The scroll wheel interface section 114 can be arranged and positioned along an axis 214 which is generally parallel to the scrod wheel rotation axis 202. Positioning of the key 206 may be to one side of the rotational axis 204 of the rotatable member 112 and at a distance from the rotatable member 112 so that a finger of a user can move between contact with the rotatable member 112 and the key 206 without substantially moving other fingers of the user so that the other fingers can be used to maintain the position or change a rotatable position of the rotatable member 112, while also allowing actuation by the user of the key 206. In other examples, the scroll wheel interface section 114 can be at any other location in the vicinity of the rotatable member 112 that allow transitional contact by a user's fingers between the rotatable member 112 and the key 206.

The indicator set 208 may be a group of indicators used to provide status information of the scroll wheel assembly 104 of which the indicator set belongs. Status information may, for example, indicate information related to a channel, when each of the scroll wheel assemblies 104 is associated with a different channel. For example, the indicator set may operate as a signal level meter for a respective channel associated with a respective scroll wheel assembly 104. Alternatively, when a group of the scroll wheel assemblies 104 are associated with a single channel, and each of the scroll wheel assemblies are associated with a parameter of the single channel, the indicator set 208 may indicate information related to one of the parameters of the single channel that is associated with the scroll wheel assembly 104. For example, an indicator set 208 of a scroll wheel assembly 104 associated with a threshold of a compressor of a single audio channel may indicate a dB level of the threshold.

The indicator set 208 may be numeric digits, illumination devices, such as LEDs, liquid crystal displays (LCDs) or any other visual indicator that is perceivable by a user. In an example embodiment, the indicator set 208 are RGB (red, green, blue) LEDs which are controlled to provide various indications in accordance with the color pattern being displayed. The grouping indicator 210 may be a numeric digit, an illumination device, such as an LED, a liquid crystal displays (LCD) or any other visual indicator that is perceivable by a user. The grouping indicator 210 may provide indication of linking of different scroll wheel assemblies. For example, where each of the scroll wheel assemblies 104 are associated with a different channel, the grouping indicator 210 may indicate channels which are paired as left and right audio channels. Alternatively, when a group of the scroll wheel assemblies 104 are associated with a single channel, and each of the scroll wheel assemblies are associated with a parameter of the single channel, the grouping indicator 210 may indicate parameter groups associated with the single channel. For example, a group of scroll wheel assemblies 104 associated with parameters of a compressor of a single audio channel may be indicated as a compressor group.

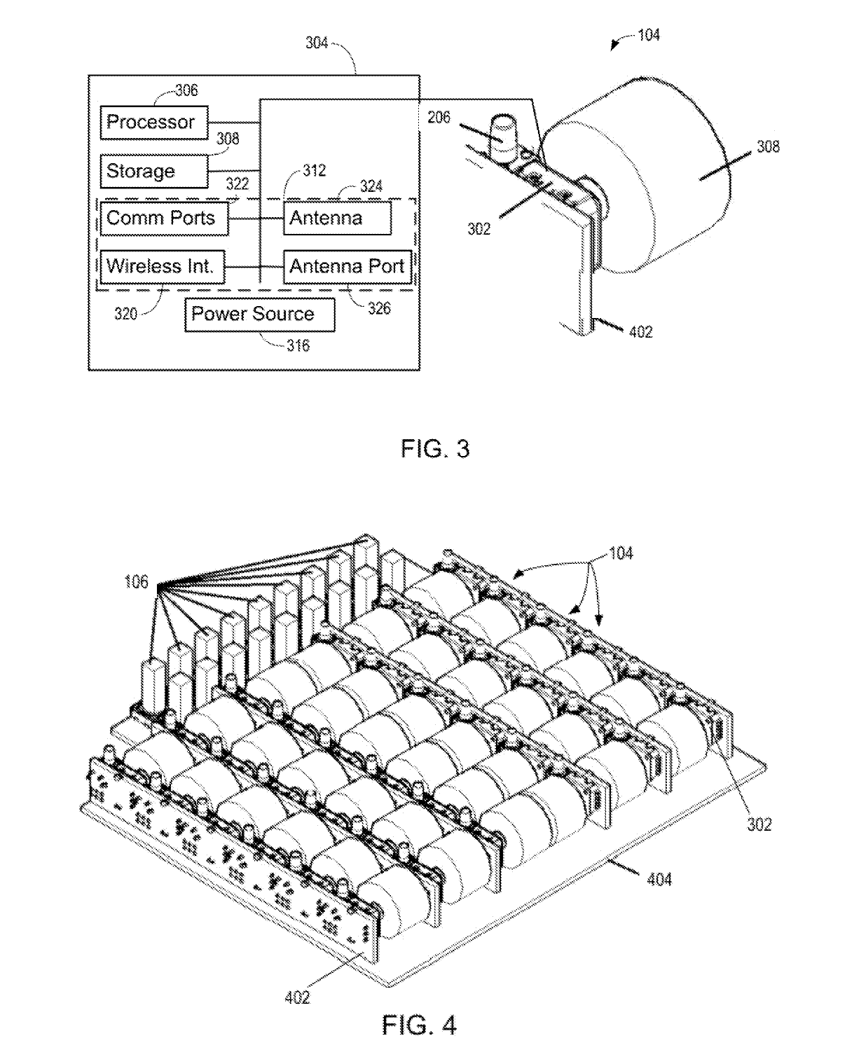

FIG. 3 is an example embodiment of a portion of the scroll wheel assembly 104 with the surface of the housing removed. In FIG. 3, the scroll wheel assembly 104 also includes a rotational movement sensing system, which in this embodiment includes a rotational sensor 302 connected to the rotatable member 112 to sense bi-directional rotation of the rotatable member 112. The rotational sensor 302 may provide a signal indicative of rotation of the rotatable member 112 to circuitry 304 included in the wireless handheld controller 100. The rotational sensor 302 may be a digital or analog device, such as a rotary encoder, that is capable of sensing rotation movement of the rotatable member 112 in either of two rotational directions. The key 206 may be an actuator that includes a contact closure. In the example embodiment illustrated, the rotatable member 112 is a wheel mounted on a vertical type rotary encoder, which is further mounted on a printed circuit board (PCB), such as by soldering, and the key 206 is a right-angle type tactile switch mounted nearby the encoder on the same PCB, such as by soldering, at a distance and location, as illustrated on FIG. 2. Rotational movement of the rotatable member 112 by a user may be provided as a rotation signal to the circuitry 304, and a frequency and duration of actuation of the key 206 by a user may be provided as a key signal to the circuitry 304.

The circuitry 304 may include a processor 306, a storage medium 308, \\and a communication interface 312. In addition, or alternatively, other elements may be included in the wireless hand held controller 100 to provide the functionality described. The wireless hand held controller 100 may also include a removable power source 316, such as a battery, to supply power to the wireless handheld controller 100, including the circuitry 304.

The processor 306 may be any form of device(s) or mechanism(s) capable of performing logic operations, and may implement a software program or firmware, such as code generated manually or programmed. The processor 306 may operate and control at least a portion of the wireless handheld controller 100. The processor 306 may communicate with other elements of the wireless handheld controller 100 via an internal communication path, such as a communication bus. The communication bus may be hardwired, may be a network, and/or may be any number of buses capable of transporting data and commands. The elements of the circuitry and the processor 306 may communicate with each other and the communication interface 312 via the communication bus.

The storage medium 308 may include a main memory, a static memory, and/or a dynamic memory. In an example, the storage medium 308 includes a cache or random access memory for the processor 306. In addition or alternatively, the storage medium 308 may be separate from the processor 306, such as a separate cache memory of a processor, system memory, or other memory used to store instructions, data and parameters.

The wireless handheld controller 100 may be assigned a unique ID for communication with other devices. The unique ID may be assigned by a user. Assignment of a unique ID by the user may involve entry of the unique ID using the rotatable member 112 and/or the function keys 106 and/or the display 108. Alternatively, assignment of the unique ID may be set by dip switches, jumpers or some other mechanically based ID setting mechanism included on or in the housing 102. In an embodiment, assignment of at least part of the unique ID may be automated, such as upon connection of the wireless handheld controller 100 to another device or network, at least a portion of a unique ID may be assigned. For example, a unique ID may be a MAC address and a TCP/IP address. The unique ID may be stored in the storage medium 308, and/or maintained with a mechanically based ID setting mechanism, such as DIP switches.

The communication interface 312 may include a wireless interface 320, one or more communication ports 322, an antenna 324, and an antenna port 326. The wireless interface 320 may be any form of device or mechanism capable of providing over the air two-way communication in a protocol, such as 802.11.

The communication ports 322 may provide a communication interface that can include any mechanism or device providing communication with other devices via one or more ports included on the wireless handheld controller 100. Such ports may include a network interface controller (NIC) port, a universal serial bus (USB™) port, Firewire™ port, or any other form of hardware port used for communication of data and commands. Thus, the communication ports 322 can provide communication over a network and/or with other devices, such as a laptop or tablet. The communication ports 322 may also include input/output capability such as analog and digital signal capability, as well as signal conversion capability such as analog-to-digital, digital-to-analog, scaling, frequency, or any other conversion technique. The communication ports 322 may also include a communication link to the antenna 324, which may be internal to housing 102, or external to the housing 102. In addition, the communication ports 322 may include a communication link to the antenna port 326 to allow connection of an external antenna or other aerial device to improve the range of wireless communication of the wireless handheld device 100.

The communication interface 312 may also include communication capability in protocols, such as RS232, RS422, USB™, Firewire™, Bluetooth™, ring bus, proprietary protocols, and/or any other communication protocol, as well as protocol conversion capabilities to convert from one protocol to another. Conversion capabilities may include conversion between physical interfaces, such as conversions related to voltages, connectors types and the like; wired protocol conversions such as RS232, RS485, RS422, CAN bus, USB™, Firewire™, Ethernet, and the like, or wireless protocol conversions such as Bluetooth™, Wi-Fi, and the like. In addition, the communication interface 312 may provide conversion between data protocols, related to how data bytes are organized, such as adding/removing a TCP header when converting between TCP and RS232, for example. Further, the communication interface 312 may provide conversion between data protocols for remote control of mixing engines or different manufacturers, such as converting between MIDI Sysex of YAMAHA and ROLAND.

During operation to remotely control one or more devices, the wireless handheld controller 100 may direct command messages to remotely controlled devices. For example, in a live sound audio application, the remotely controlled device may be a mixing engine, and the command message may be to control, adjust, and/or reconfigure the audio channels in an audio signal. An example is adjustment of a mix of input audio channels that are used by the mixing engine to form an output audio signal which is the main audio output to an audience in a venue. Another example is adjustment of a mix of input audio channels that are used by the mixing engine to provide a monitor mix for one or more performers. In addition, the wireless handheld controller 100 can be used for adjustment of parameters of individual channels which are controlled by the mixing engine. Example parameters include volume, tone, effects, compressors, gates, pan or any other feature related to audio channels. In other applications, such as lighting applications, the wireless handheld controller 100 may remotely control a lighting control surface to control such activities as the sequencing of scenes, sequencing of individual lights, colors and/or intensity of lighting fixtures.

FIG. 4 illustrates an example embodiment of a wireless handheld controller 100 with a portion of the housing 102 removed. In FIG. 4, configuration and relative locations of embodiments of the scroll wheel assemblies 104 illustrated in FIG. 3 are shown. The scroll wheel assemblies 104 may be mounted in rows on mounting members 402 to form columns of scroll wheel assemblies 104 such that rotatable members 112 and keys 206 are positioned in vertical rows, and scroll wheel interface section 114 are positioned in horizontal rows. Several of the mounting members 402 may be positioned in parallel on a base member 404 to form a series of columns of the scroll wheel assemblies 104. The mounting members 402 and the base member 404 may be planar members formed of any rigid material capable of fixedly maintaining the position of the scroll wheel assemblies 104 and the mounting members 402, respectively. In an embodiment, the mounting members 402 are printed circuit boards which are vertically oriented and formed to provide a structural and electrical connection to the rotational sensors 302 and the keys 206. The function keys 106 may also be mounted on the base member 404. In the illustrated embodiment, both the scroll wheel assemblies 104 and the function keys 106 are mounted on a single base member 404. In other example embodiments, the base member 404 may include multiple separate planar members.

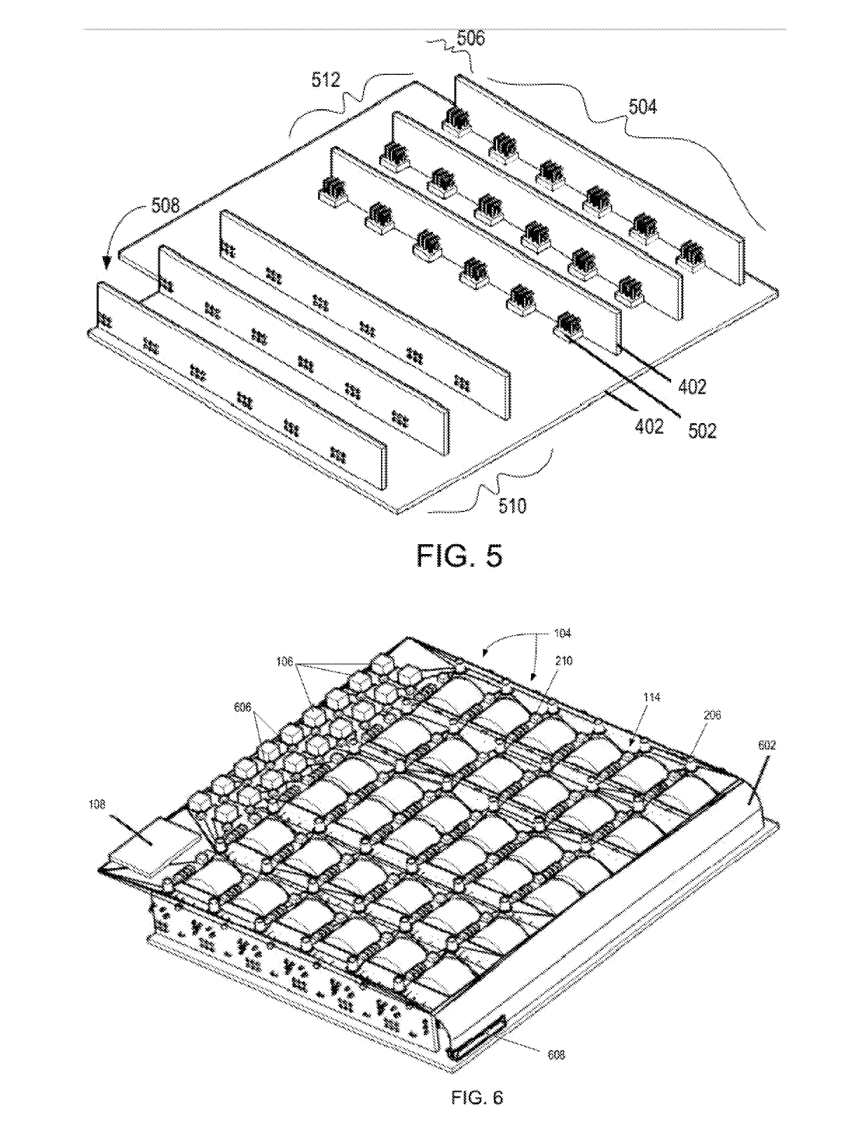

FIG. 5 is an example embodiment illustrating a portion of the wireless handheld controller with the scroll wheel assemblies 104 removed. As illustrated in FIG. 5, the mounting members 402 can be rigidly coupled with the base member 404 by a coupling mechanism 502. The coupling mechanism 502 may be positioned adjacent to each location of a scroll wheel assembly 104 to provide structural support to fixedly maintain the rotatable member 112 in position in an opening in the housing 102. In addition, the coupling mechanism 502 may provide an electrical connection between the scroll wheel assemblies 104 and the circuitry 304. In the illustrated embodiment multiple mounting members 402 in the form of PCBs are mounted to the base member 404 in the form of a main PCB by coupling mechanisms 502 that are pin headers, as shown in FIG. 5. In this embodiment, the pin headers may be used as joints that mechanically connect the PCBs forming the mounting members 402 and the base member 404 together, as well as electrically connecting these PCBs together to form electronic circuits that are part of the communication bus of the circuitry 304. In one example, the mounting members 402, the coupling mechanisms 502, and the base member 404 may be soldered.

The base member 404 may include a first area 504 for the rows of the mounting members 402. In addition, the base member 404 may include a second area 506 in which the function keys 106 may be mounted. In an embodiment where the base member 404 is a PCB, the function keys 106 may be structurally and electrically coupled with the base member 404 such that the function keys 106 may be rigidly held in position, and electrically coupled with the circuitry 304. The base member 404 may be formed to include a notch 508 to accommodate a display. As discussed later, the display is mounted on and electrically connected with a flexible overlay such that the display is disposed in the notch 508. In other embodiments, the notch 508 may be a display mount for mounting the display in the housing such that the notch 508 may include electrical connections at or near the edge of the PCB forming the base member 404 to connect the display to the communication bus of the circuitry 304. As indicated in FIGS. 4 and 5, the columns of mounting members are also separated into a first side group 510 and a second side group 512. In an embodiment, the first side group 510 can be for operation with the left hand of a user, and the second side group can be for operation with the right hand of a user. Accordingly, as best illustrated in FIG. 5, the mounting members 402 are equidistantly positioned on the base member 404 and act as barriers between different columns of scroll wheel assemblies 104, except for those mounting members 402 which are nearest the boundary between the first and second side groups 510 and 512. For the two mounting members 402 that are nearest the boundary between the first and second side groups 510 and 512, the scroll wheel assemblies 104 associated therewith are adjacently located without mounting member 402 there between to provide an ergonomic design for the left and right hands of a user.

FIG. 6 illustrates another embodiment of a portion of the wireless handheld controller 100, which includes a flexible overlay 602. The flexible overlay 602 may be formed to include wheel openings through which each of the scroll wheel assemblies 104 protrude, and key openings through with the keys 206 protrude. In addition, the flexible overlay 602 may include function key openings through which the function keys 106 protrude. Also, the flexible overlay may be coupled with a display 108, function indicators 606 which are each associated with a respective function key 106, and indicator sets 208 and grouping indicators 210 from the scroll wheel interface sections 114 which are each associated with a respective scroll wheel assembly 104. In addition, the flexible overlay 602 may include a connector 608.

In an example embodiment, the flexible overlay 602 may be a flexible PCB that forms an electrical connection to the communication bus of the circuitry 304. In this embodiment, the display 108 may be electrically coupled with the flexible overlay 602, and the flexible overlay may be electrically connected with the base member 404. The function indicators 606 and the connector 608 may also be electrically coupled with the base member 404 via the flexible overlay 602. In other embodiments, the elements may be otherwise electrically connected to the communication bus of the circuitry 304.

The display 108 may be a liquid crystal display (LCD) or any other form of user perceivable data presentation to a user. The function indicators 606 may indicate a current status of a respective function key 106. The function indicators 606 may indicate status with two or more states of operation, such as illuminated or not illuminated to indicate on/off states, or red/green/blue to indicate three different states of a corresponding function key 106. The connector 608 may be included as part of the communication ports 322. In an example embodiment, the connector 608 may be one or more of an edge connector, a USB port, or any other form of hardware port for communication.

The scroll wheel interface section 114 includes the key 206, the indicator set 208, and the grouping indicator 210 which may provide an interface for the respective scroll wheel assemblies 104, as previously discussed.

User Interface Functionality/Operation

The following embodiments of a user interface are based on the previously described hardware elements of the control surface of the wireless handheld controller 100. Although the control surface is described with respect to audio systems and mixing audio, use of the wireless handheld controller 100 is not limited to audio, and the following discussion should not be construed as limiting.

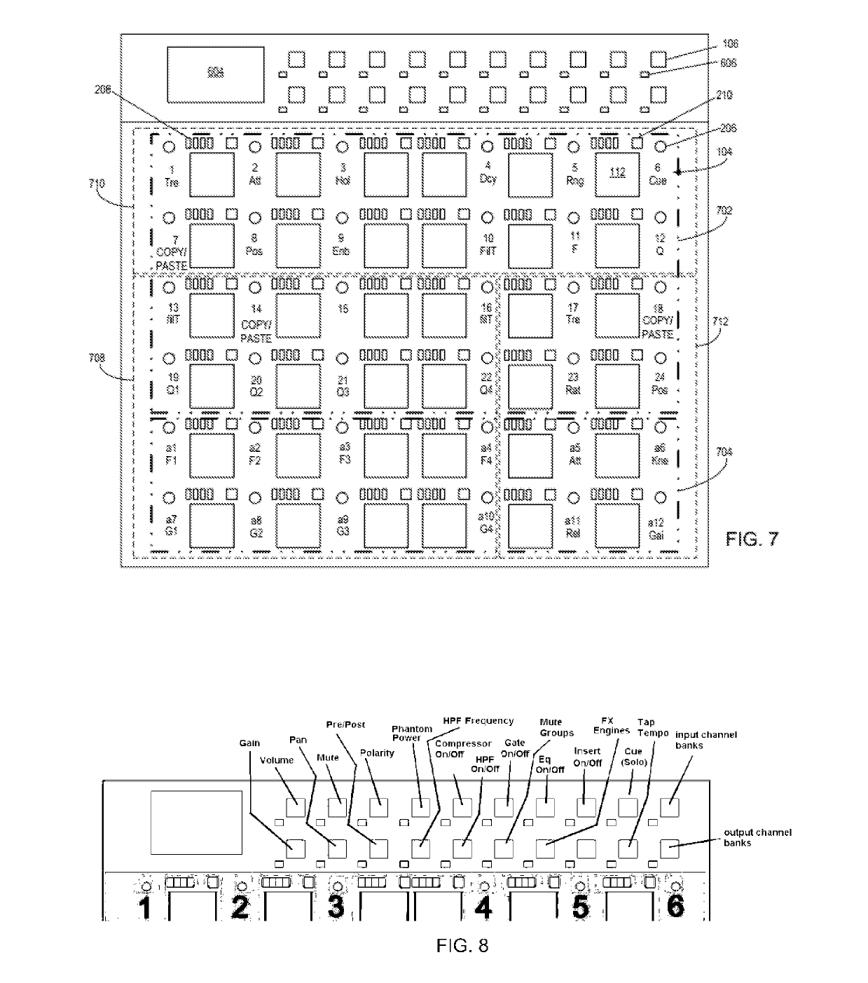

FIG. 7 is a block diagram of an example user interface 700 of the wireless handheld controller 100, which depicts the scroll wheel assemblies 104, the function keys 106, the function indicators 606, and the display 108. Within the user interface 700, a first block group of input channels 702 may be several top rows of blocks associated with respective scroll wheel assemblies 104. In the embodiment of FIG. 7, there are four rows of input channels (1-24), and thus four rows of blocks and corresponding scroll wheel assemblies 104. In addition, the user interface 700 may include a second block group of mix output channels 704, which may be several bottom rows of blocks associated with respective scroll wheel assemblies 104. In the embodiment of FIG. 7 there are two rows of mix masters (a1-a12).

In an example embodiment of the wireless handheld controller 100 used in audio mixing, the user interface is switchable between three modes: a first mode which is a Main mode, a second mode which is a Channel Send mode, and third mode which is a Channel Edit mode.

The main mode is a mode in which input audio channels are mixed for a selected audio mix. In the main mode, the rotatable members 112 of respective scroll wheel assemblies 104 each control parameters of a different channel in the mix. The controlled parameters of a channel by default is Volume, but other parameters of a channel can be selected with the function keys 106, as discussed later. In addition, the default indication of the indicator set 208 in each scroll wheel assembly 104 is a signal level of the respective channel, however, upon selection of a function key 106, the indicator set 208 in each scroll wheel assembly 104 changes to indicate a parameter associated with the selected function key 106.

The Channel Send mode, or monitor mix mode, is a mode in which a selected input channel is sent to multiple output mixes. In the channel send mode, the rotatable members 112 of respective scroll wheel assemblies 104 control selected channel mix sends to mixes.

A user can toggle between the main mode and the channel send mode by selecting a respective channel using the key 206 of the one of the scroll wheel assemblies 104 associated with that respective channel in the first block group 702. For example, to switch from Main mode to Channel Send mode for a second channel send, a user can select the second channel within the first block group 702 by selecting the key 206 of the scroll wheel assembly 104 associated with channel two. Once channel two is selected, the scroll wheel assemblies 104 remain associated with the channels 1-24, and can be used to send controls for respective mixes of channels 1-24 to the second channel send.

A user may also select a mix master by selecting a channel a1-a12 in the second block group 704 by selecting a key 206 of a scroll wheel assembly 104 included in the second block group 704. When a mix master is chosen by selecting the key 206 of one of the scroll wheel assemblies 104, the scroll wheel assemblies 104 of the second block group (a1-a12) become mix master dials to matrix mixes m1-m12. This makes sense because mixes can be configured as bus groups by making mix sends from “variable” to ‘fixed”.

A user can tell at glance whether the wireless handheld controller 100 is active in the Main mode or the Channel Send mode by observing readings of display 108. For example, whenever in the Channel Send mode the display 108 can display the selected channel number and whenever in the Main mode the display 108 can display a predetermined character such as “A” (for “mix”) or “M” (for “Matrix”) followed by a number of the output mix selected. To quit the Channel Send mode, and return to the Main mode, a user can select any key 206.

The Channel Edit mode is an which various parameters of a single selected input or output channel are accessible for adjustment scroll wheel assemblies 104, since all of the scroll wheel assemblies in a group are associated with the single channel. To enter the Channel Edit mode, a user can select a key 206 of a scroll wheel assembly associated with a channel two times briefly within a short period of time, which may also be referred to as a “double-click”, to set the user interface in Channel Edit mode. The Channel Edit mode may also be referred to as a “Channel Strip” mode. In this mode each of the scroll wheel assemblies 104 become control for parameters of a single channel, such as EQ and dynamics such as a gate and a compressor, of the single channel. By “double-clicking” on the key 206 of a selected channel, all the scroll wheel assemblies 104 become controls for the channel strip.

In FIG. 7, a first parameter group 708 of scroll wheel assemblies 104 become associated with EQ parameters control, a second parameter group 710 of scroll wheel assemblies 104 become associated with gate parameters, and a third parameter group 712 of scroll wheel assemblies 104 become associated with compressor parameters. In addition, each of the respective indicator sets 208 may provide an indication of the value of the respective parameter of the single selected channel while in the channel edit mode.

As illustrated in the embodiment of FIG. 7, within the first parameter group 708 for EQ parameters, there are four different filters available to control the Q (Q1-Q4), the frequency (F1-F4), and the gain (G1-G4), using the associated scroll wheel assemblies 104. The first filter can be used for low frequencies, the second filter for low-mid frequencies, the third filter for high-mid frequencies, and the fourth filter for high frequencies. The first and the fourth filter include an extra control for filter type (filT) to allow selection between bell/shelf/bandpass filter types using the rotatable members 112 of the respective scroll wheel assemblies 104.

Within the second parameter group 710 for gate parameters, the controls are Threshold (Tre), Attack (Att), Hold (Hol), Decay (Dcy), Range (Rng), Cue (Cue), GatePosition (Pos), FilterEnable (Enb), FilterType (filT), FilterFrequency (F), FilterQ (Q), using the associated scroll wheel assemblies 104.

Within the third parameter group 712 for compressor parameters, the controls are Threshold (Tre), Ratio (Rat), Attack (Att), Release (Rel), CompressorPosition (Pos), Knee (Kne), Gain (Gai), using the associated scroll wheel assemblies 104.

Within each of the first, second and third parameter groups 708, 710 and 712, there is a Copy/Paste control 716 using the associated scroll wheel assemblies 104 to toggle between COPY and PASTE. Once EQ or Gate or Compressor parameter values are selected by a user for copying, then when entering other channels the Copy/Paste control can come up as COPY and for a user to perform a paste operation, it needs to be toggled to PASTE using the respective rotatable member 112. A user may quit the Channel Edit Mode and return to the Main Mode by “double-click” of any key 206.

As previously discussed, selection by a user of any of the function keys 106 assigns the function selected to be controlled by all of the scroll wheel assemblies 104 for the associated channels. In addition, a selected function key 106 may be indicated with the respective indicator function 606. Using the function keys 106 and associated function indicators 606, a user can conveniently control and read the readings of the same parameters over all the channels. The function keys 106 may be used in the Main mode or the Channel Send mode to control and manage parameters of channels.

FIG. 8 illustrates a portion of a user interface 800, showing examples of various functions for use in audio mixing, such as checking whether phantom power is on or off, whether the phase reversed or not, whether one or more channels are muted or not, whether the channel equalizer is on or off, whether the channel dynamic effect is on or off, etc. By activating a function key 106, the function of the scroll wheel assemblies 104 associated with the channels change accordingly. For example, if the function key 106 assigned to control Mute is selected, rotation of any one of the rotatable members 112 toggles the mute of the respective associated channel on or off. In other examples, selection of the functions for Polarity, PhantomPower, Cue (Solo), CompressorON/OFF, GateON/OFF, EqON/OFF, InsertON/OFF, HPF ON/OFF, MuteSafe, RecallSafe can also toggle the same way for any selected channel. Preamp Gain, Pan or HPFrequency may also be accessible via function keys 106 rather than in Channel Edit mode.

The above operational functionality of the function keys 106 is described for the Main mode. However, when in Channel Send mode, the function keys 106, operational functionality may be different. For example, Mute in the Channel Send mode can toggle Channel Send to mix on/off. In addition, some of the function keys 106 may only be operational in the Channel Send mode, while others function keys 106 may be operational in both the Main mode and the Channel Send mode. For example, a dedicated function key 106 Pre/Post can toggle Channel Send to show channel meters for channels (scroll wheel assemblies 104) as mix Pre EQ or Post EQ. This dedicated function key 106 to toggle Pre/Post would toggle mix Master Pre/Post (when all Channel Sends to this mix become Pre or Post in one go). A user can also tell at glance which function is currently assigned to the scroll wheel assemblies 104 and indicated by the indicators set 208 by observing which of the function keys 106 is illuminated.

A dedicated function key 106 may also take care of Mute Groups. When the function key 106 is selected, each of the scroll wheel assemblies 104 become Mute masters. In this mode, rotating one of the rotatable members 112 toggles the associated mute master on and off. When the function key is “double clicked,” channels to MuteGroups can now be assigned by rotating the rotatable members 112 until the desired MuteGroups are set, as indicated by the grouping indicator 210, such as by a color of an RGB LED. Whether the grouping indicator 210 displays link groups or mute groups can be controlled by toggling a dedicated function key 106. A dedicated function key 106 can also be used to take care of FX Engine configuration. FX engines may be selected by repeatedly selecting a dedicated function key 106 to cycle through a number of choices of FX engines, until the right FX engine is selected. The rotatable members 112 can become controls for various FX engine parameters as well as be preset selectors within such engines. The display 108 may display names for the controls. Also, a Tap Tempo control (click) may be a dedicated function key 106. In addition a dedicated function key 106 Input Channel Banks can control which bank of channels (1-24, 25-48, etc.) is currently displayed. The function indicator 606 associated with this function key can provide indication of the currently selected bank of channels, such as by providing RGB illumination accordingly. In addition, or alternatively, the display 108 may also indicate which channel range is currently selected. In addition, a dedicated key 106 may control which bank of mix masters (a1-a12 or a13-a24, m1-m12, etc.) is currently displayed. The function indicator 606 associated with this function key can provide indication of the currently selected bank of channels, such as by providing RGB illumination accordingly, and/or the display 108 may similarly indicate.

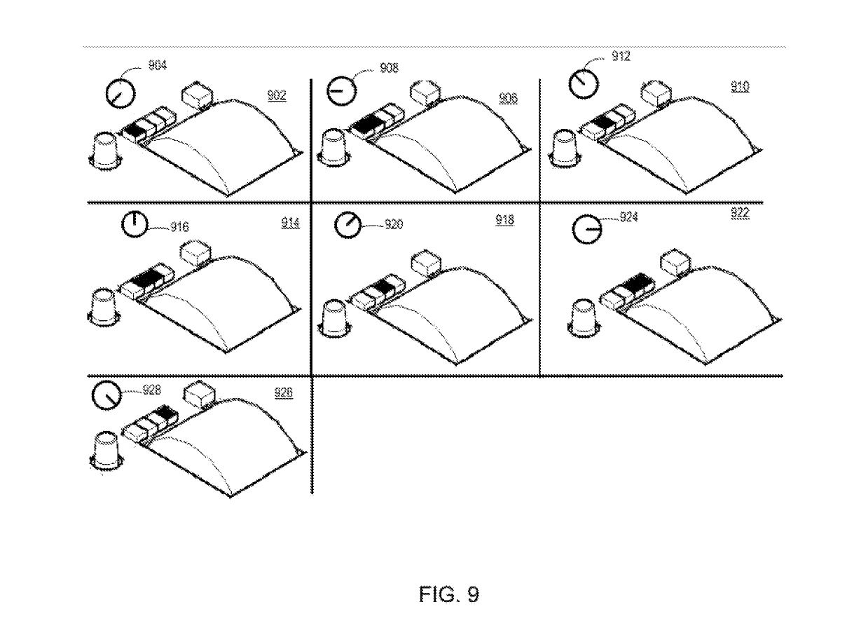

FIG. 9 is an example of operation of the indicator set 208 included in the scroll wheel interface section 114. The indicators in the indicator set 208 may work in several modes, toggled between the modes by the key 206. In a default mode associated with the main mode and the channel send mode, the indicator set 208 provides a signal level meter indication for each of the channels; in another mode (channel edit mode), indicator set 208 can provide indication of current state of parameters controlled by scroll wheel assemblies 104 for a selected single channel. For example, whenever a function key 106 is selected during the main or the channel send mode, the indicator set 208 may be changed for each respective scroll wheel assembly to a display a current state of the selected function for the respective channel. Alternatively, when operating in the channel edit mode, each of the indicator sets 208 may indicate a parameter of the respective single channel.

In the example operating scheme of FIG. 9, the indicator set 208 is a number of illumination devices or parts, such as LEDs, however, as previously discussed, the indicator set 208 should not be so limited. In the illustrated embodiment the indicator set 208 includes four LED parts. Lighting up the LEDs, counting from left to right, a parameter state, such as a knob position, may be indicated in the following manner as illustrated in FIG. 9 (the LEDs that are lit up are illustrated in black in FIG. 9). In a first scenario 902, whenever only the far left part is lit up the indicator set 208 represents the knob position as “seven o'clock” as illustrated in the clock dial 904. In a second scenario 906, whenever the far left and center left parts are lit up the indicator set 208 represents the knob position as “nine o'clock”, as illustrated in the clock dial 908. In third scenario 910, whenever only the center left part is lit up the indicator set 208 represents the knob position as “eleven o'clock”, as illustrated in the clock dial 912. In a fourth scenario 914, whenever center left and center right parts are lit up the indicator set 208 represents the knob position as “twelve o'clock”, as illustrated in the clock dial 916. In a fifth scenario 918, whenever only the center right part is lit up the indicator set 208 represents the knob position as “one o'clock”, as illustrated in the clock dial 920. In a sixth scenario 922, whenever the center right and far right parts are lit up the indicator set 208 represents the knob position as “three o'clock”, as illustrated in the clock dial 924. In a seventh scenario 926, whenever only the far right part is lit up the indicator set 208 represents the knob position as “five o'clock” as illustrated in the clock dial 928.

As previously discussed, the grouping indicator 210 may, by default indicate channels are linked (grouped, paired). To link channels, a user may press and hold the keys 206 of the scroll wheel assemblies 104 associated with the channels desired to be grouped. After a predetermined period of time, the channels become linked (grouped, paired), and the grouping indicator 210 may indicate the channels are linked. For example, when the grouping indicators 210 are RGB LEDs, channels may be indicated as linked by the grouping indicators 210 showing the same color of different channels. To unlink, (ungroup, break pairs) a user may similarly hold down the keys 206 of the linked channels for a determined period of time until the channels become free as indicated by the respective grouping indicators 210, such as by ceasing to display the same RGB color.

The methods, devices, processing, and logic described above may be implemented in many different ways and in many different combinations of hardware and software. For example, all or parts of the implementations may be circuitry that includes an instruction processor, such as a Central Processing Unit (CPU), microcontroller, or a microprocessor; an Application Specific Integrated Circuit (ASIC), Programmable Logic Device (PLD), or Field Programmable Gate Array (FPGA); or circuitry that includes discrete logic or other circuit components, including analog circuit components, digital circuit components or both; or any combination thereof. The circuitry may include discrete interconnected hardware components and/or may be combined on a single integrated circuit die, distributed among multiple integrated circuit dies, or implemented in a Multiple Chip Module (MCM) of multiple integrated circuit dies in a common package, as examples.

The circuitry may further include or access instructions for execution by the circuitry. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed as circuitry among multiple system components, such as among multiple processors and memories, optionally including multiple distributed processing systems. Parameters, databases, and other data structures may be separately stored and managed, may be incorporated into a single memory or database, may be logically and physically organized in many different ways, and may be implemented in many different ways, including as data structures such as linked lists, hash tables, arrays, records, objects, or implicit storage mechanisms. Programs may be parts (e.g., subroutines) of a single program, separate programs, distributed across several memories and processors, or implemented in many different ways, such as in a library, such as a shared library (e.g., a Dynamic Link Library (DLL)). The DLL, for example, may store instructions that perform any of the processing described above or illustrated in the drawings, when executed by the circuitry.

Various implementations have been specifically described. However, many other implementations are also possible.

1. A device comprising:
a housing;
a plurality of scroll wheel assemblies mounted in said housing, each of said scroll wheel assemblies including a rotatable member and a key adjacently associated with respective rotatable members; and
circuitry in electrical communication with said scroll wheel assemblies, said circuitry being configured to control said device and provide remote control of equipment in communication with said device;
said circuitry comprising a movement sensing system configured to sense movement of said rotatable member, and a key sensing system configured to sense a mode signal received from said key; and
said circuitry configured to operate in a first mode initiated with said mode signal in which each one of said plurality of scroll wheel assemblies are representative of one of a plurality of input channels, and a second mode initiated with said mode signal in which each one of said plurality of scroll wheel assemblies are representative of parameters of only one of said plurality of input channels.

2. The device of claim 1, wherein said input channels are audio input channels, and in said second mode, said circuitry is configured to group said scroll wheel assemblies such that a first group of scroll wheel assemblies are associated with equalization signals of said only one of said plurality of audio input signals, a second group of scroll wheel assemblies are associated with gate signals of said only one of said plurality of audio input signals, and a third group of scroll wheel assemblies are associated with compressor signals of said only one of said plurality of audio input signals.

3. The device of claim 1, wherein said channels are at least one of an audio channel or a lighting channel, and said equipment in communication with said device is at least one of an audio system or a lighting system.

4. The device as in any of claims 1-3, wherein each of said rotatable members are bi-directionally rotatable, and said key is an actuator comprising a contact closure.

5. The device as in any of claims 1-4, wherein rotational movement of said rotatable members represents different parameter adjustment signals in different modes.

6. The device as in any of claims 1-5, further comprising a display and a plurality of indicators coupled with said circuitry and included in said housing, wherein said indicators are organized in groups and positioned in said housing such that each of said groups is associated with a respective scroll wheel assembly.

7. The device of claim 6, wherein a group of indicators is operable in a default mode as a channel signal level meter, or as indicators of a function selected by one of said function keys, while said circuitry is operable in said first mode, and wherein said group of indicators is indicative of a parameter state while said circuitry is operable in said second mode.

8. The device as in any of claims 1-7, wherein said housing includes a plurality of openings in a surface of said housing, said rotatable members are rotatable about an axis extending parallel with said surface of said housing and are laterally movable relative to said housing within respective openings, and said keys are positioned within respective openings to be adjacently associated with respective rotatable members.

9. The device of claim 8, wherein said movement sensing system is configured to sense lateral movement of said rotatable member relative to said housing.

10. The device as in claims 8 or 9, wherein said keys are respectively positioned to one side of a respective rotational axis of said rotatable members and at a distance from said rotatable members that enables a finger of a user to move between contact with said rotatable member and said key without substantially moving other fingers of said user.

11. A method comprising:
receiving with circuitry included in a device a plurality of input signals, said input signals received from any of a plurality of respective scroll wheel assemblies, and being indicative of rotation of a respective rotatable member included in each of said respective scroll wheel assemblies;
said circuitry, during operation in a first mode, associating each of said input signals with adjustment of a respective one of a plurality of channels in accordance with one of said scroll wheel assemblies from which a respective input signal was received;
said circuitry, during operation in a second mode, associating each of said input signals with adjustment of a respective one of a plurality of parameters of only one of said channels in accordance with a respective one of said scroll wheel assemblies from which said input signal was received;
transmitting, with said circuitry, said input signals as respective first output signals to adjust different channels of remote equipment in response to said input device being operable in said first mode; and
transmitting, with said circuitry, said input signals as respective second output signals to adjust parameters of only one of said channels of said remote equipment in response to said device being operable in said second mode.

12. The method of claim 11, further comprising receiving with said circuitry a mode signal from one of a plurality of keys included in said housing which are respectively associated with one of said scroll wheel assemblies; toggling, with said circuitry, said device from said first mode to said second mode in response to receipt of said mode signal; and identifying, with said circuitry, said only one of said channels of said remote device based on said one of said plurality of keys from which said mode signal was received.

13. The method of claim 12, wherein said first mode is a first output mix, and the method further comprises receiving another mode signal from one of said plurality of keys indicative of a third mode; in response to said another mode signal the method further comprising: placing said device in said third mode with said circuitry; associating each of said input signals with adjustment of a respective one of a plurality of channels of said second output mix in accordance with one of said scroll wheel assemblies from which a respective input signal was received, said second output mix being different and autonomous from said first output mix.

14. The method as in any of claims 11-13, wherein said single channel is a single audio channel, and the method further comprises said circuitry grouping said scroll wheel assemblies in response to said second mode signal such that a first group of scroll wheel assemblies are associated with equalization signals of said single audio channel, a second group of scroll wheel assemblies are associated with gate signals of said single audio channel, and a third group of scroll wheel assemblies are associated with compressor signals of said single audio channel.

15. The method as in any of claims 11-14, wherein during operation in said first mode, each of said input signals is associated with adjustment of an identical first function of said respective plurality of channels, and the method further comprising said circuitry receiving a function signal from one of a plurality of function keys during said first mode, said circuitry, in response to receipt of said function signal, associating each of said input signals with adjustment of an identical second function of said respective plurality of channels, wherein said first function and said second functions are different functions.

16. The method as in any of claims 11-15, further comprising receiving a function signal during said first mode, changing a plurality of respective indicators of respective channels from a default indication of a signal level, to indication of a parameter associated with said selected function for each respective channel, and during said second mode said respective indicators providing indication of a value of said respective one of said plurality of parameters of said only one of said channels, said plurality of respective indicators associated with respective scroll wheel assemblies.

17. The method of claim 16, wherein each of said indicators comprises a plurality of visual indicators, the method further comprising in said first mode, visually adjusting said state of said visual indicators with said circuitry in response to changes in said signal level or changes in said parameter associated with said selected function, and in said second mode in response to changes in said value of said respective one of said plurality of parameters of said only one of said channels.

18. The method of claim 17, further comprising selectively illuminating said visual indicators in different sequences to indicate different values of selected parameters associated with corresponding functions.

19. A device comprising:
a housing;
a plurality of scroll wheel assemblies, each of said scroll wheel assemblies comprising:
a rotatable member to generate a variable input signal to control remote equipment;
a key positioned adjacent to said rotatable member, said key actuated to generate a mode signal to change operation of said rotatable member among a plurality of modes, said plurality of modes including a first mode in which variable input signals from rotatable members in respective scroll wheel assemblies are channel input signals for adjustment of respective different channels of remote equipment, and a second mode in which variable input signals from rotatable members in respective scroll wheel assemblies are parameter input signals for adjustment of respective different parameters of a single channel of remote equipment; and
an indicator positioned adjacent to said rotatable member, said indicator being a visual indicator providing information related to a channel associated with said rotatable member within one of said respective modes.

20. The device of claim 19, further comprising circuitry electrically coupled with each of said scroll wheel assemblies, said circuitry comprising a movement sensing circuit configured to sense lateral movement of said rotatable member and generate a corresponding output signal.

21. The device of claim 19 or 20, further comprising a plurality of function keys dedicated to pre-determined functions and configured to generate respective function signals, a function of each of said scroll wheel assemblies being changed in accordance with a selected function key in said first mode, but not in said second mode.

22. The device as in any of claims 19-21, wherein in said first mode, each of said rotatable members are associated with a different audio channel, and in said second mode, each of said rotatable members are representative of different parameters of only a single audio channel.

23. The device as in any of claims 19-22, wherein each of said rotatable members include a uniformly cylindrical surface and are positioned in said housing such that only a part of said uniformly cylindrical surface extends out of said housing, and said uniformly cylindrical surface is laterally movable with respect to said housing to rotate said rotatable member.
